(19) United States
(12) Patent Application Publication
(10) Pub. No.: US 2009/0157530 A1
(43) Pub. Date: Jun. 18, 2009

(54) Data processing device and data processing method

(75) Inventors: Satoru Nagamoto, Kobe-shi (JP); Nobutaka Ukyoh, Kobe-shi (JP); Yasuhiro Ohno, Kobe-shi (JP); Ikuo Ohta, Tokyo (JP)

Correspondence Address: OLIFF & BERRIDGE, PLC, P.O. BOX 320850, ALEXANDRIA, VA, 22320-4850, US

(73) Assignees: FUJITSU TEN LIMITED, KOBE-SHI (JP); MEDIA CLICK INC., TOKYO (JP)

(21) Appl. No.: 12/314,001

(22) Filed: Dec. 2, 2008

(30) Foreign Application Priority Data
Dec. 3, 2007 (JP) 2007-312782

(51) Int. Cl. G06Q 30/00; G06F 15/16

(52) U.S. Cl. 705/27; 709/218

(57) ABSTRACT

Included are reproduction processing unit that reproduces a content distributed as carried on broadcasting waves, display unit that displays an image making distinguishable the content that is in a reproducing process by the reproduction processing unit, request accepting unit that accepts a purchase request for the content corresponding to the image displayed on the display unit, and code generating unit that generates a predetermined code readable by a mobile terminal on the basis of unique identifying information contained in the content having the purchase request accepted by the request accepting unit.

### CROSS-REFERENCE TO RELATED APPLICATIONS

This application is based upon and claims the benefit of priority of the prior Japanese Patent Application No. 2007-312782, filed on Dec. 3, 2007, the entire contents which are incorporated herein by reference.

### BACKGROUND

The present invention relates to a data processing device and a data processing method.

Over the recent years, there has been known a technology of distributing information etc about music contents and advertisements via broadcasting waves for FM character multiple broadcasts to an audio system and a car data processing device including the audio system. For example, Patent document 1 discloses a technology of storing music content information acquired from the FM character multiple broadcasts in a storage device, and downloading, based on user's judgment, the music content data related to the music content information stored therein from a Web server on the Internet.

[Patent document 1] Japanese Patent Laid-Open Publication No. 2001-298430

### SUMMARY

In recent years, there has been known the technology of distributing the information etc about the music contents via the broadcasting waves for the FM character multiple broadcasts etc to the audio system and the navigation equipment including the audio system. This type of conventional technology enables a user to purchase, e.g., the music content etc on the basis of the distributed information. A matter of concern about the conventional technology is, however, that the music contents are hard to be recognized, and a music content different from the music content actually having a purchase request might be selected. Namely, what is desired is a development of a technology capable of surely purchasing the requested music content by a simple operation on the occasion of the purchase. Further, the audio system having none of a communication function has a problem that the music contents etc can not be purchased.

It is an object of the present invention to provide, in view of the problems described above, a technology capable of readily purchasing contents distributed via the broadcasting waves.

### Means for solving the Problems

According to the present invention, in order to solve the problems given above, a purchase request is accepted in a way that displays an image making a content distinguishable, and a code readable on a mobile terminal is generated for the content having the acceptance of the purchase request.

Specifically, according to the present invention, a data processing device comprises: reproduction processing unit that reproduces a content distributed as carried on broadcasting waves; display unit that displays an image making distinguishable the content that is in a reproducing process by the reproduction processing unit;

request accepting unit that accepts a purchase request for the content corresponding to the image displayed on the display unit; and code generating unit that generates a predetermined code readable by a mobile terminal on the basis of unique identifying information contained in the content having the purchase request accepted by the request accepting unit.

According to the present invention, the purchase request is accepted in a way that displays the image making the content distinguishable, whereby it is feasible to reduce such a situation that the user might mistakenly purchase the content. Namely, according to the present invention, the user can surely purchase the requested content by a simple operation. A data processing device is exemplified by an audio system and navigation equipment including the audio system.

The content reproduced by the reproduction processing unit is distributed as carried on the broadcasting waves. The content contains various categories of information such as music content information and advertisements. The broadcasting waves are exemplified by radio waves transmitted from a transmitting device installed at broadcasting stations which broadcast radio broadcasts, multiple broadcasts, TV broadcasts and digital broadcasts. According to the present invention, the contents are distributed by utilizing these existing infrastructures, and hence a user can obtain various categories of information free of charge.

The display unit displays the image making an on-reproduction content distinguishable. This scheme, according to the present invention, enables the user to surely grasp at a glance the on-reproduction content. The image making the content distinguishable may be either a static image or a dynamic image. Further, the request accepting unit accepts a purchase request for the content corresponding to the image displayed on the display unit. According to the present invention, it is therefore possible to purchase the content while confirming the image.

The code generating unit generates a predetermined code associated with the content of which the purchase is accepted. The predetermined code can be read on the mobile terminal The mobile terminal previously incorporates a communication function and therefore, according to the present invention, can purchase the content from on the data processing device having none of the communication function.

Herein, according to the present invention, the code generating unit may generate the predetermined code and may get the thus-generated predetermined code displayed in a way that replaces the image displayed on the display unit. The predetermined code is displayed on the display unit and can be thereby read by the mobile terminal. Moreover, the user can recognize that the predetermined code has been generated.

Further, according to the present invention, the predetermined code can involve using QR code (registered trademark) readable on the mobile terminal. The predetermined code is not particularly limited but can be easily generated by use of a QR code and can be readily read on the mobile terminal. Moreover, the predetermined code may involve using a character code containing content identifying information. In this case, the character code can be read on the mobile terminal through wireless communications. The predetermined code may contain, in addition to the content identifying information, identifying information of the data processing device.

It should be noted that the present invention may also be a content distribution system including the data processing device described above. To be specific, the content distribution system comprises: a transmitting device transmitting a content encrypted by a content providing device for providing the content in order to restrict a reproducing process in a way that carries the content on broadcasting waves; a data processing device receiving the content transmitted by the transmitting device and executing the reproducing process of the content; and a mobile terminal transmitting identifying information contained in the content, which is reproduction-processed by the data processing device, to the content providing device, and acquiring a release key for canceling the restriction of the reproducing process from the content providing device, and the data processing device includes: receiving unit receiving the content to which the restriction of the reproducing process is applied; reproduction processing unit executing the reproducing process of the content received by the receiving unit; code generating unit; code generating unit generating a predetermined code readable on the mobile terminal with respect to the content requested by a user in the contents undergoing the reproducing process by the reproduction processing unit; and decryption processing unit decrypting the content to which the restriction of the reproducing process is applied on the basis of the release key acquired by the mobile terminal.

Herein, if the data processing device does not incorporate the communication function accessible to the content providing device, such a problem has hitherto existed that the content can not be purchased. Further, even if the data processing device has the communication function. there still exists the problem that the content can not be purchased unless the data processing device is preinstalled with a program that can support an accounting system administered by the provider. By contrast, according to the present invention, a fee can be charged for purchasing the content and the release key can be acquired by utilizing the mobile terminal, and hence, even when the data processing device has no communication function, the content can be readily purchased. Moreover, according to the present invention, the various categories of information can be transmitted by providing the transmitting device.

The content distributed according to the present invention is previously encrypted in the content providing device, and undergoes the restriction of the reproducing process. The restriction of the reproducing process connotes applying the restriction so that an introduction and a catchy part of a piece of music content defined as the content are listening-enabled. It is to be noted that the content providing device belongs to a content provider, and the content provider is exemplified by a music content provider, a news distributor, a recording company, a CD shop, etc. Further, the data processing device includes the decryption processing unit, whereby the encrypted content can be easily decrypted based on the release key acquired by the mobile terminal.

It should be noted that the code generating unit may generate the predetermined code for the content having the user's purchase request, the mobile terminal may acquire the release key issued when charging a fee for the content having the user's purchase request, and the decryption processing unit may decrypt the content to which the restriction of the reproducing process is applied on the basis of the release key acquired by the mobile terminal and issued when charging the fee for the content. According to the present invention, the release key is issued when charging the fee, i.e., when settlement is normally implemented, and therefore the content can be purchased surely, highly efficiently and in safety.

Still further, according to the present invention, the content may be music content information about a piece of music, and the transmitting device may transmit the fee-charging music content information restricted so as to listening-enable only a part of the music content by its being encrypted in the content providing device in a way that carries the music content information on broadcasting waves. According to the present invention, the music content can be provided with high efficiency.

Further, the present invention may also be a method or a program for realizing processes executed by the content distribution system and by the data processing device, the transmitting device, the mobile terminal and the content providing device, which build up the content distribution system. Still further, the present invention may also be a readable-by-computer recording medium recorded with such a program. In this case, the computer etc is made to read and execute the program on this recording medium, whereby the function thereof can be provided. Note that the recording medium readable by the computer etc connotes a recording medium capable of storing information such as data and programs electrically, magnetically. optically, mechanically or by chemical action, which can be read from the computer etc. According to the present invention, it is feasible to provide the technology capable of readily purchasing the content distributed by utilizing the broadcasting waves.

### BRIEF DESCRIPTION OF DRAWINGS

FIG. 1 is a diagram illustrating an outline of an architecture of a content distribution system in the embodiment.

FIG. 2 is a diagram of function blocks of a transmitting device.

FIG. 3 is a diagram illustrating one example of a music content information database.

FIG. 4 is a diagram illustrating an outline of a configuration of navigation equipment.

FIG. 5 is a diagram of function blocks of the navigation equipment.

FIG. 6 is a diagram of function blocks of a mobile terminal.

FIG. 7 is a diagram of function blocks of a content providing device.

FIG. 8 is a flowchart illustrating a flow of a music content information transmitting process.

FIG. 9 is a flowchart illustrating a flow of a code generating process.

FIG. 10 is a diagram illustrating a channel selection screen.

FIG. 11 is a diagram illustrating a purchase acceptance screen.

FIG. 12 is a diagram illustrating a screen on which the QR code is displayed.

FIG. 13 is a flowchart illustrating a flow of a code process and a release key transmitting process.

FIG. 14 is a diagram illustrating a state where the QR code is read by a mobile terminal.

FIG. 15 is a diagram illustrating a display state on the mobile terminal.

FIG. 16 is a diagram illustrating a flow of an accounting process and a release key issuing process.

### DESCRIPTION OF EMBODIMENTS

An embodiment of the data processing device of the present invention will be described in a way that exemplifies a content distribution system including the data processing device. Note that the embodiment will exemplify a case of distributing music content information as a content to the data processing device.

### <Architecture>

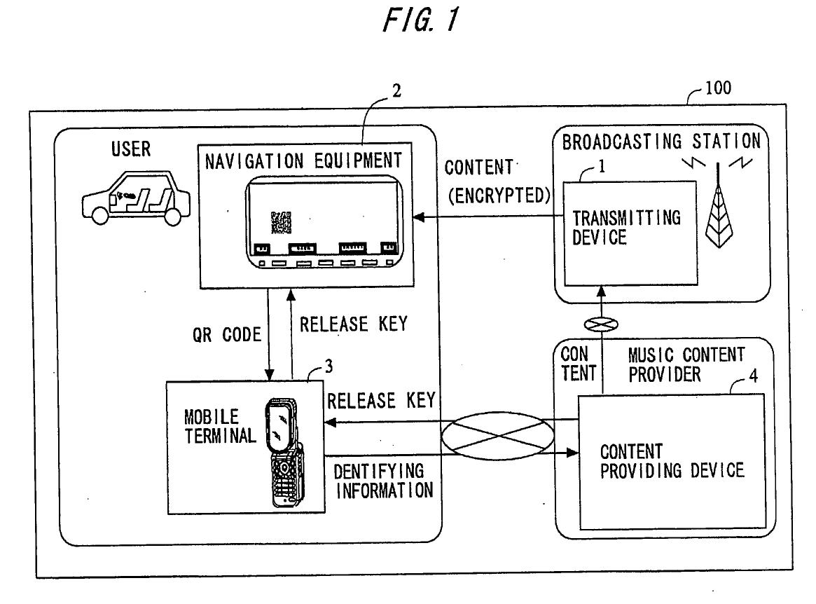

FIG. 1 illustrates an outline of an architecture of the content distribution system in the embodiment. As illustrated in FIG. 1. a content distribution system 100 in the embodiment is configured by a transmitting device 1 installed at a broadcasting station, navigation equipment 2 and a mobile terminal 1 that are possessed by a user, and a content providing device 4 installed at a music content provider.

### (Transmitting Device)

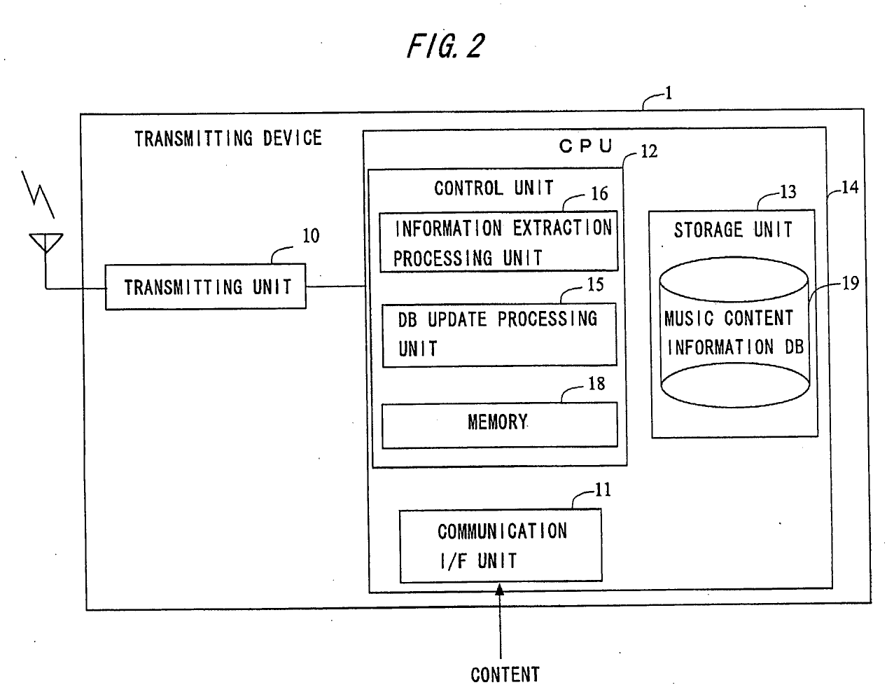

The transmitting device 1 is provided at a broadcasting station that broadcasts a radio broadcast, a multiplex broadcast, a TV broadcast and a digital broadcast, and transmits the music content information as carried on broadcasting waves. Herein, FIG. 2 illustrates a block diagram of function blocks of the transmitting device 1. The transmitting device 1 includes a communication interface unit 11, a CPU (Central Processing Unit) 14, a control unit 12, a storage unit 13 and a transmitting unit 10. Further, the control unit 12 includes a database update processing unit 15, an information extraction processing unit 16 and a memory 18. Incidentally, advertisements etc can be also transmitted in place of the music content information.

Note that the control unit 12 can be also configured as a computer program running on the CPU 14. The CPU 14 is connected via an unillustrated bus to respective hardware components such as the control unit 12 and the storage unit 13, then controls these hardware components, and executes predetermined process according to a control program stored in the memory 18. Note that the memory 18 includes a volatile RAM (Random Access Memory) and a nonvolatile ROM (Read Only Memory). The ROM includes a rewritable semiconductor memory such as a flash memory, an EPROM (Erasable Programmable Read-Only Memory) and EEPROM (Electrically Erasable Programmable Read-Only Memory).

The communication interface unit 11 receives the music content information transmitted from the content providing device 4 installed at the music content provider. The music content information received by the communication interface unit 11 is sent to the control unit 12. The communication interface unit 11 can be built up by a communication device such as a LAN (Local Area Network) board. Note that the communication interface unit 11 may perform bidirectional communications with the content providing device 4. The content providing device 4 will be described later on.

The database update processing unit 15 executes a part of the processes carried out by the control unit 12. To be specific, the database update processing unit 15 stores a music content information database 19 with the music content information transmitted from the communication interface unit 11. For example, the database update processing unit 15 stores the music content information in the music content information database 19 in a way that associates the music content information with items (fields) such as a name of music content, a name of artist, a date/time of event and a place of event.

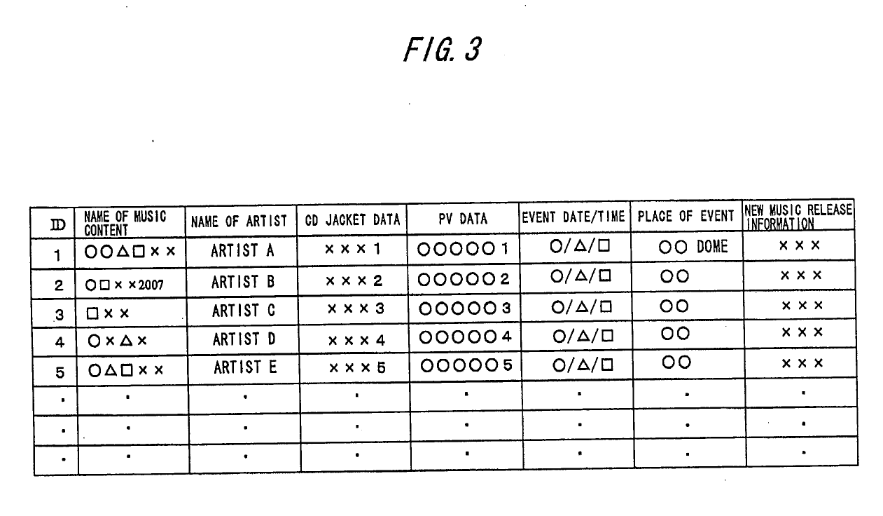

The storage unit 13 has the music content information database 19 stored with the music content information. Herein, FIG. 3 illustrates one example of the music content information database 19. The music content information contains, in addition to information directly related to the music content such as music data and a title of the music data, artist information and event information that are associated with the music content. Further, the artist information includes image information exemplified by static and dynamic images such as a CD jacket image and a profile image of the artist, and also includes character information exemplified by the event information such as a concert of the artist, profile information and new music release information. It is preferable that the music content information database 19 be structured as a relational database and be stored with the music content information associated with key items such as TOC (Table of Contents) defined as identifying information (recording information) of a CD, a name of music and a name of artist. It is to be noted that the storage unit 13 can be constructed of a large-capacity storage device such as a storage apparatus and a storage system.

The information extraction processing unit 16 executes a part of the processes carried out by the control unit 12. Specifically, the information extraction processing unit 16 extracts relevant pieces of music content information corresponding to a broadcasting schedule from the music content information database 19, and transmits the thus-extracted music content information to the transmitting unit 10. For example, the information extraction processing unit 16 extracts ranking information of the music content information provider and the music content information corresponding to the pieces of music broadcasted in programs of the broadcasting station.

The transmitting unit 10 transmits the music content information undergoing an encrypting process in the way of being carried on the broadcasting waves. To be specific, the transmitting unit 10 transmits the music content information in parallel with a radio program and a TV program via a broadcasting channel different from broadcasting channels used for the normal broadcasting data. The transmitted music content information is, it follows, received by the navigation equipment 2 of the user.

Incidentally, in addition to the components, the transmitting device 1 may be provided with an operation unit and a display unit. The operation unit can be constructed of an input device such as a keyboard and a pointing device of a computer. The display unit can be built up by, e.g., a liquid crystal display device, a plasma display panel, a CRT (Cathode Ray Tube), an electroluminescence panel, and so on.

### (Navigation Equipment)

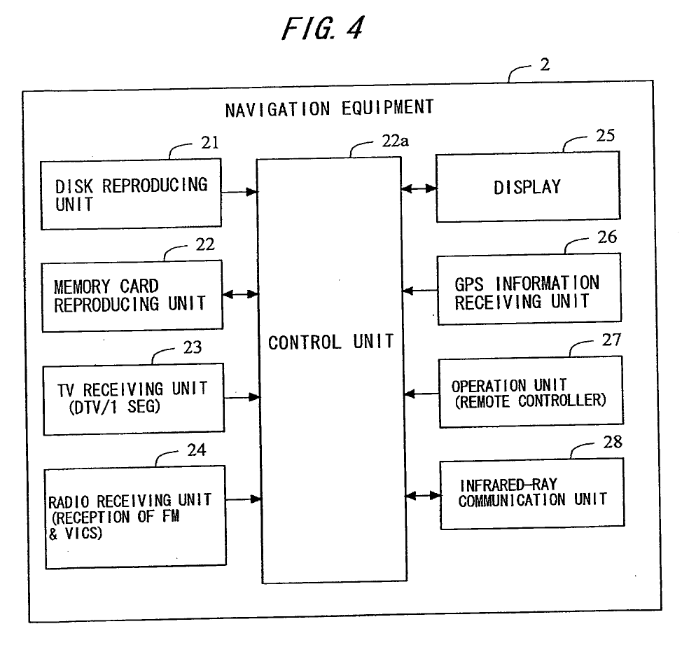

The navigation equipment (corresponding to a data processing device according to the present invention) 2 mounted in a vehicle will be described. Herein, FIG. 4 illustrates an outline of a configuration of the navigation equipment 2. The navigation equipment 2 in the embodiment includes a disk reproducing unit 21, a memory card reproducing unit 22, a TV receiving unit 23, a radio receiving unit 24, a display 25, a GPS information receiving unit 26, an operation unit 27, an infrared-ray communication unit 28, and a control unit 22a electrically connected to these components.

The disk reproducing unit 21 reproduces contents recorded on a CD, a DVD, etc. The disk reproducing unit 21 can be constructed of a CD/DVD deck. The memory card reproducing unit 22 reproduces the contents stored on a mobile storage medium such as a USB (Universal Serial Bus) memory and an SD (Secure Digital) memory card. The TV receiving unit 23 receives a DTV (Digital Television) broadcast and a one-segment (1 seg) broadcast. The TV receiving unit 23 can be constructed of an existing tuner. The radio receiving unit 24 receives an FM broadcast. an AM broadcast, VICS (Vehicle Information and Communication System) information, etc. The radio receiving unit 24 can be constructed of an existing tuner. Note that the TV receiving unit 23 or the radio receiving unit 24 can acquire the music content information transmitted from the transmitting device 1.

The display 25 displays, in addition to the map information and guide routes, the music content information transmitted as carried on the broadcasting waves from the transmitting device 1. It is preferable that the display 25 is of a touch panel type, however, multiple existing displays can be applied to the display 25. The GPS information receiving unit 26 receives the GPS information. The GPS information receiving unit 26 can be constructed of an existing GPS receiving antenna. The operation unit 27 transmits an electric signal corresponding to the operation button to the control unit 12. The operation unit 27 may be provided in the navigation equipment 2 and may also be a remote controller enabling remote control to be done. The infrared-ray communication unit 28 receives the infrared rays output from the mobile terminal 3.

Incidentally, the navigation equipment 2 may be a portable navigation equipment demountable from the vehicle. In this case, the navigation equipment 2 may take a configuration having a built-in speaker and a built-in memory card in addition to the components described above. The speaker outputs a voice reproduced by the disk reproducing unit 21 and the memory card reproducing unit 22. The memory card is exemplified by the mobile storage medium such as the USB memory and the SD memory card.

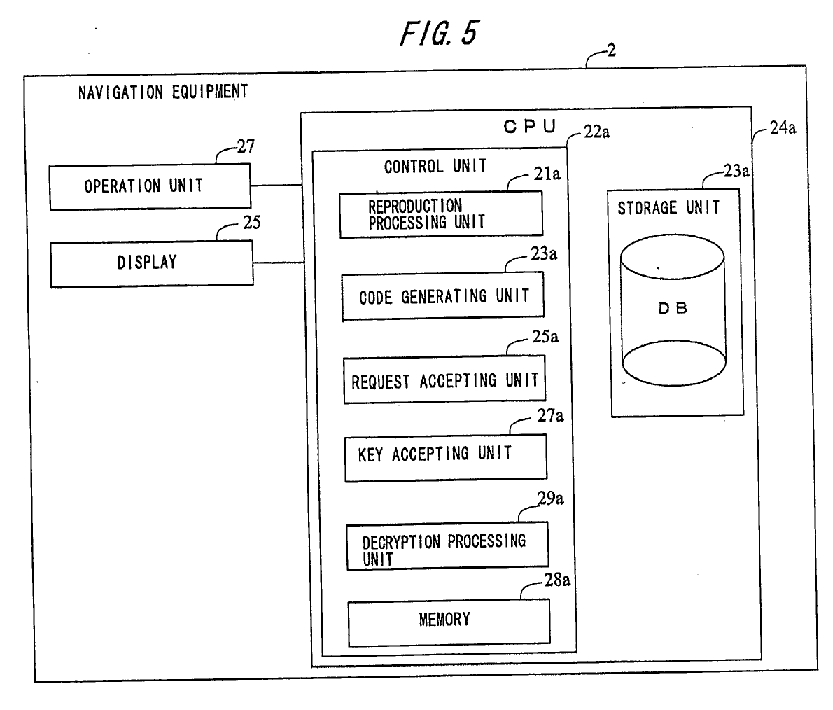

Next, the control unit 22a of the navigation equipment 2 will be described. FIG. 5 illustrates a diagram of function blocks of the navigation equipment 2. As illustrated in FIG. 5, the control unit 22a includes a reproduction processing unit 21a, a code generating unit 23a, a request accepting unit 25a, a release key accepting unit 27a, a decryption processing unit 29a and a memory 28a. It is to be noted that the control unit 22a can be realized by a computer including a CPU, a memory, etc and by a program running on the computer. Further, the control unit 22a is provided with, in addition to the components described above, a traffic jam information acquiring unit, a destination setting unit, etc (unillustrated), which take fundamental functions of the navigation equipment.

The reproduction processing unit 21a executes a reproducing process of the music content information received by the radio receiving unit 24 or the TV receiving unit 23 (which will hereinafter be termed the radio receiving unit 24 etc). Specifically, the reproduction processing unit 21a stores the storage unit 23a with the music content information undergoing the encrypting process, which has been received by the radio receiving unit 24 etc, and executes the reproducing process of only a reproducible data i.e., free-of-charge audio/video-enabled data. The reproducing process includes, in addition to reproducing the sound information of the music content, displaying the static image such as the image of the CD jacket, reproducing the moving picture (dynamic image) and displaying a title of the music data. For instance, the reproduction processing unit 21a displays a plurality of titles to be reproduced on the display 25, sequentially reproduces the sound information of the free-of-charge audio/video-enabled data and displays, with respect to the on-reproduction music content, the image of the CD jacket on the display 25. This display scheme enables the user to recognize at a glance the title etc of the music content to which the user is now listening.

The request accepting unit 25a accepts a user's purchase request for the music content now undergoing the reproducing process via the operation unit 27. For example, the request accepting unit 25a accepts the user's purchase request through a purchase button displayed together with the image of the CD jacket of the on-reproduction music content. Incidentally, in the case of the touch panel display, the purchase request may also be accepted from the display 25.

The code generating unit 23a executes a code process about the music content having the purchase request. Specifically. the code generating unit 23a specifies the title name and an ID of the music content having the purchase request, and generates and displays a QR (Quick Response) code (registered trademark) on the display 25. The generation of the QR code involves determining a version and a cell size and is done based on necessary items of information such as the title information of the-music content, the ID unique to the music content, a URL (Uniform Resource Locator) of a site of the provider from which this music content can be purchased, and a serial number of the navigation equipment 2. The generation of the QR code can be realized by an existing QR code generating program.

Note that the QR code, which is the two-dimensional code, is used as the code in the embodiment, however, the present invention is not limited to the QR code. The available code is a code enabling the necessary items of information such as the title information of the music content and the ID unique to the music content to be recorded and read by the mobile terminal. Accordingly, for instance, the necessary items of information such as the title information of the music content, the ID unique to the music content, the URL of the site of the provider from which the music content can be purchased and the serial number of the navigation equipment, may also be character-coded and displayed on the display 25. The character-coded information can be read by the mobile terminal by use of the wireless communication technologies such as Bluetooth (registered trademark) and FeliCa (registered trademark).

The release key accepting unit 27a accepts a release key needed for decrypting the encrypted music content information from the mobile terminal 3. The release key can be accepted from the mobile terminal 3 via the infrared-ray communication unit 28. The acceptance is not, however, limited to this scheme. The release key may also be accepted via other types of wireless communication technologies such as Bluetooth (registered trademark) and FeliCa (registered trademark). Moreover, the user may also directly input the release key via the operation unit 27. In this case, a preferable scheme is that a further encrypted code is inputted for improving the security. A further encryption method is exemplified by a method of inputting both of a key code used when encrypting the information on the mobile terminal and at the site of the music content provider and the encrypted release key, a method of encrypting the information by use of a serial ID of the product, attaching the serial ID to the release key and inputting the encrypted serial ID, and so on.

The decryption processing unit 29a decrypts a predetermined piece of encrypted music content in the music content information on the basis of the release key accepted by the release key accepting unit 27a. Namely, the music content with the acquired release key is selected from within the music content information stored in the storage unit 23a, and the selected music content is subjected to the decrypting process. The decrypted music content is released from the restraint, and the user can listen to the decrypted music content without any restriction.

### (Mobile Terminal)

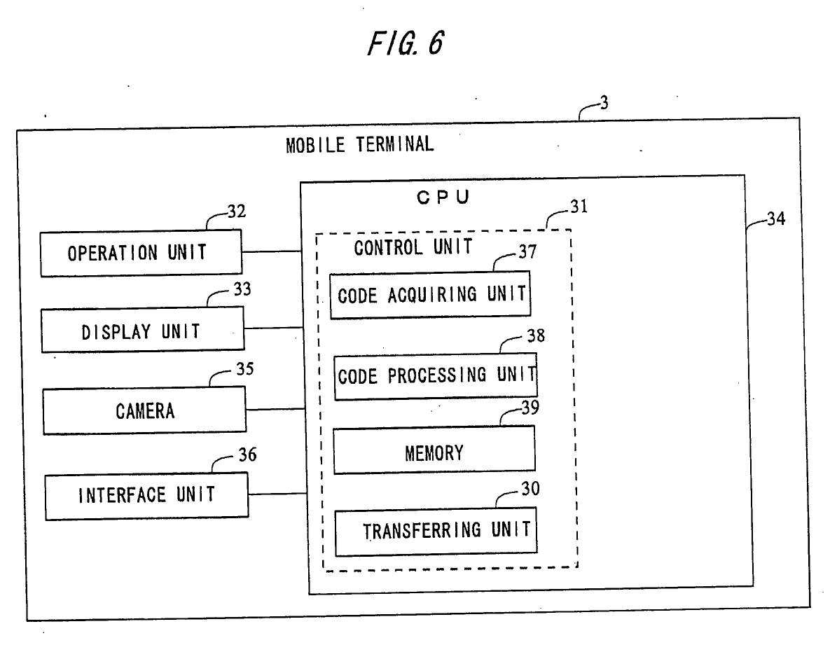

Next, the mobile terminal 3 will be explained. The mobile terminal 3 reads the code (the QR code in the embodiment) of the purchase-requested music content, and acquires the release key for decrypting the encryption-processed music content with a content subscription fee cleared. Herein, FIG. 6 illustrates a diagram of function blocks of the mobile terminal 3. As illustrated in FIG. 6, the mobile terminal 3 includes a CPU 34, a control unit 31, an operation unit 32, a display unit 33, a camera 35 and an interface unit 36 connectable to an external device. Further, the control unit 31 includes a code acquiring unit 37, a code processing unit 38, a memory 39 and a transferring unit 30.

The CPU 34 is connected to the respective hardware components, and executes a predetermined process according to a control program stored in, e.g., a ROM serving as the memory 39. The memory 39 includes a volatile RAM and a nonvolatile ROM. The operation unit 32 may be a general type of operation button needed for operating the mobile terminal 3 and may also be of a touch display type. The interface unit 36 in the embodiment is constructed of an infrared-ray port communicable with the navigation equipment 2. The interface unit 36 is, however, sufficient if electrically connectable to the navigation equipment 2 irrespective of a wired or wireless connection The interface unit 36 may be a connector for connecting a cable, and may also take Bluetooth (registered trademark). The code acquiring unit 37 acquires the QR code displayed on the display 25 of the navigation equipment 2 via the camera 35.

The code processing unit 38 reads the information contained in the QR code acquired by the code acquiring unit 37, and executes a predetermined process. To be specific, the code processing unit 38 reads the title, the ID, the URL and the serial number of the navigation equipment 2, which are contained in the QR code, and displays these pieces of data on the display unit 33. Further, the code processing unit 38, when the URL displayed on the display unit 33 is selected, accesses the selected URL, i.e., a Web site of the music content provider. A web page of the music content provider is displayed on the display unit 33, and it is feasible to clear the content subscription fee and acquire the release key by inputting the necessary items of information containing the user's identifying information for purchasing the music content. Note that the code processing unit 38 can be configured by an existing QR code reading program executable by the CPU 34. Incidentally, when acquiring the character codes containing the items of information such as the title, the ID, the URL and the serial number of the navigation equipment 2 by use of the wireless communication technologies like Bluetooth and FeliCa, the code processing unit 38 can read and display these character codes on the display unit 33.

The transferring unit 30 transfers the release key acquired by the code processing unit 38 to the navigation equipment 2 via the interface unit 36. The transferring unit 30 can be also configured as a computer program running on the CPU 34. Note that the program configuring the transferring unit 30 may be incorporated into the program configuring the code processing unit 38. The memory 39 is stored with the variety of control programs needed for the mobile terminal 3. i.e., the programs configuring the code processing unit 38 and the transferring unit 30.

### (Content Providing Device)

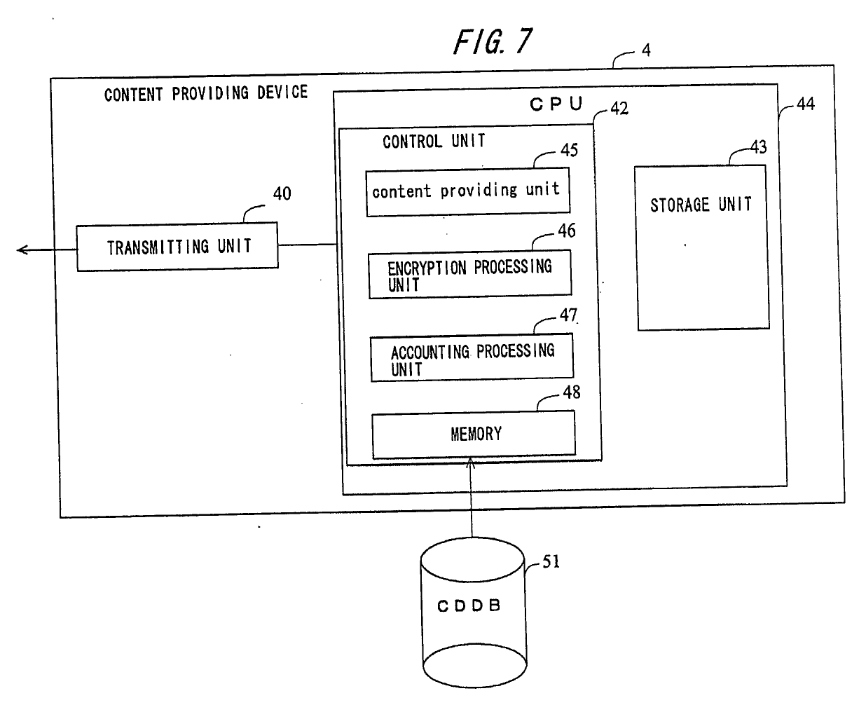

Next, the content providing device 4 will be described. The content providing device 4, which is installed at the music content provider, provides the music content information etc to the transmitting device 1 of the broadcasting station, and performs accounting process for the user. Herein, FIG. 7 illustrates a diagram of a function blocks of the content providing device 4. As illustrated in FIG. 7, the content providing device 4 includes a storage unit 43, a CPU 44 and a control unit 42. The control unit 42 includes a content providing unit 45, an encryption processing unit 46, an accounting processing unit 47 and a memory 48.

The content providing unit 45 accesses an external CDDB 51 (CDDB (registered trademark): Compact Disc Data Base) and extracts a predetermined piece of music content information from the CDDB 51. The encryption processing unit 46 sets an ID for every music content, and performs the encrypting process so as to make only some pieces of received information in the transmitted pieces of music content information confirmable to the navigation equipment 2. For example, the encryption processing unit 46 gives a restriction to the music content information so that the user can listen to only an introduction and a catchy part free of charge. In other words, the encryption processing unit 46 executes the encrypting process so as to enable the user to listen to the music parts other than the listening-enabled part on the free-of-charge basis only when using the release key associated with the ID unique to the music content, and thereafter transmits the music content information to the broadcasting station via the network from the transmitting unit 41 Note that the encryption processing unit 46, when executing the encrypting process, issues the release key for decrypting the encrypted music content information, and stores this key per music content in the storage unit 43.

The accounting processing unit 47 transmits the release key in response to the purchase request given from the mobile terminal 3. Specifically, the accounting processing unit 47 extracts from the storage unit 43 the release key associated with the music content of which the purchase is requested by the user on the basis of the ID of the music content that is inputted to the Web page. Further, the accounting processing unit 47, after confirming the clearance of the content subscription fee, provides the extracted release key to the mobile terminal 3. Note that the accounting processing unit 47 may provide the release key on the Web page and by separately transmitting this key by mail etc.

### <Processing Flow>

A content distribution processing flow conducted by the content distribution system 100 according to the embodiment will be described. The following discussion will deal with a case where the broadcasting station distributes the fee-charging music content information of which only a part is listening-enabled. Further, the following discussion will also deal with processes executed respectively by the transmitting device 1, the navigation equipment 2, the mobile terminal 3 and the content providing device 4. Note that these processes are executed in such a way that the CPUs of the individual devices and equipment read predetermined programs.

### (Music Content Information Transmitting Process)

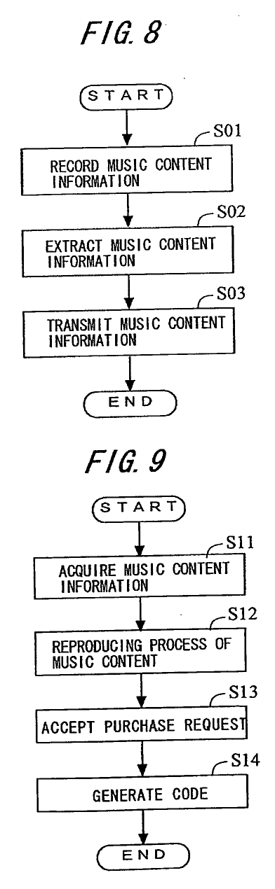

To start with, a music content information transmitting process executed by the transmitting device 1 will be described. FIG. 8 illustrates a flow of the music content information transmitting process carried out by the transmitting device 1. In step S01, the music content information received by the communication interface unit 11 is recorded on the music content information database 119. The music content information is a previously-encryption-processed and fee-charging music content stored in the CDDB 51 installed externally and provided via the content providing device 4. When completing the acquisition of the music content information, the operation proceeds to step S02.

In step S02, a relevant piece of music content information is extracted from the music content information database 19 corresponding to the broadcasting schedule. Subsequently in step S03, the extracted (already-encrypted) music content information is transmitted as carried on the broadcasting waves. Upon completing the transmission of the music content information, the navigation equipment 2 receives the music content information and executes the code generating process in response to the user's purchase request.

### (Code Generating Process)

Next, the code generating process executed by the navigation equipment 2 will be explained. FIG. 9 illustrates a flow of the code generating process. In step S11, the music content information transmitted as carried on the broadcasting waves from the transmitting device 1 is acquired by the radio receiving unit 24 or the TV receiving unit 23. The acquired music content information is recorded in the storage unit 23a of the navigation equipment 2. When the acquisition of the music content information is completed, the operation proceeds to step S12.

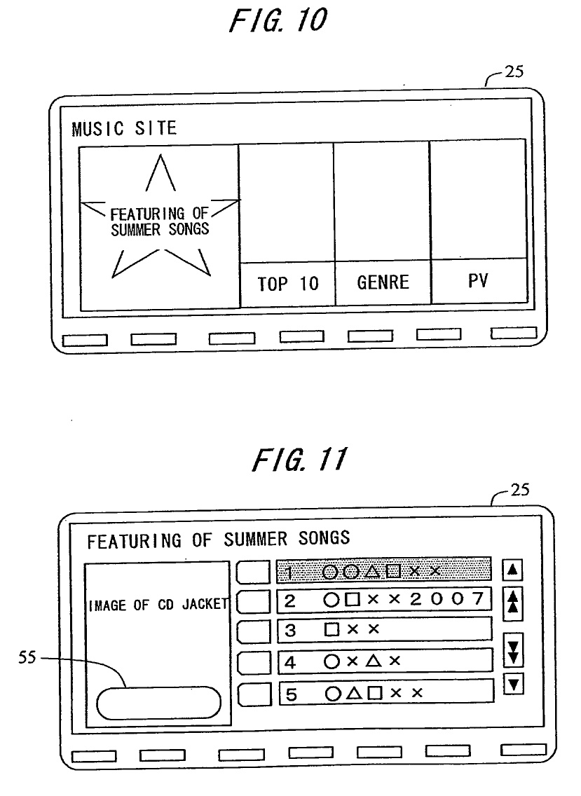

In step S12, the reproducing process of the music content is started. To be specific, the execution of the reproducing process of the music content information is triggered by selecting a start button (unillustrated) on the operation unit 27 or the display 25 of the navigation equipment 2, and a channel selection screen is displayed. Herein, FIG. 10 illustrates the channel selection screen. As illustrated in FIG. 10, a plurality of channels such as “Featuring of summer songs”, “TOP 10”, “Genre” and “PV” is displayed in a selectable mode on the channel selection screen. “Featuring of summer songs” is extracted by use of the “season” as a keyword, “TOP 10” is extracted based on ranking information of the music content provider, “Genre” is selected according to categories such as traditional-style Japanese popular songs, pop music and classic music, and “PV” represents the music content with a promotion video (PV). Note that the reproducing process is performed by selecting the start button on the operation unit 27 or the display 25 of the navigation equipment 2, i.e., before the channel is selected in the embodiment. The reproducing process of the music content is not, however, limited to this execution timing and may also be started after selecting the channel. Incidentally, the music content information is encrypted, and hence the reproducing process is conducted so that only the free-of-charge and listening-enabled part such as the catchy part is reproduced. Upon the start of the reproducing process, the operation proceeds to step S13.

In step S13, the user's purchase request for the music content information is accepted. Herein, FIG. 11 illustrates a purchase acceptance screen. Note that FIG. 11 illustrates a case where “Featuring of summer songs” in FIG. 10 is selected by the user. As illustrated FIG. 11, the image of the CD jacket of the on-reproduction music content and the titles of the plurality of music contents extracted as “Featuring of summer songs”, are displayed on the purchase acceptance screen. Further, a purchase button 55 is provided under the image of the CD jacket. Accordingly, in the case of requesting the purchase, the user may simply select the purchase button 55 provided on the display 25. Note that when “Featuring of summer songs” is selected, the music contents 1 through 5 extracted as “Featuring of summer songs” are sequentially generated at intervals of a predetermined period of time (e.g., 10 sec), and the image of the CD jacket is also changed over synchronizing with the music content that is in the generating process. The reproducing-process-enabled part is only, e.g., the catchy part which the user can listen to free of charge, however, on the occasion of wanting to re-listen to the music content, the repetitive listening can be done simply by selecting the title of the want-to-re-listen-to music content. When the acceptance of the user's purchase request is completed, the operation proceeds to step S14.

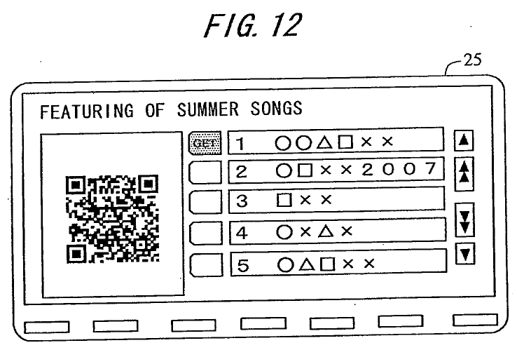

In step S14, the music content having the purchase request undergoes the code generating process. Specifically, the QR code is generated based on the title and the ID of the music content of the music content having the purchase request, the URL of the purchase destination and the serial number of the navigation equipment 2, and the thus-generated QR code is displayed on the display 25. Herein, FIG. 12 illustrates a screen on which the QR code is displayed. As illustrated in FIG. 12, the QR code corresponding to the music content having the user's purchase request is displayed in the position (see FIG. 11) where the CD jacket is displayed. The QR code displayed contains the title and the ID of the music content of the music content having the user's purchase request, the URL of the purchase destination, etc. Incidentally, [GET] is displayed on the left side of the title of the music content of which the purchase has been completed. As a result, the user can grasp at a glance the music content of which the purchase has been completed. The code generating process is completed by the operation described above. According to the embodiment, though the QR code is generated, the character codes including the items of information such as the title and the ID, the URL and the serial number of the navigation equipment 2, may be generated and displayed. The generated character codes can be read on the mobile terminal 3 by use of the wireless communication technologies such as Bluetooth and FeliCa.

### (Code Process/Release key Transmitting Process)

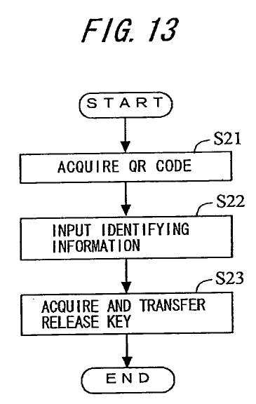

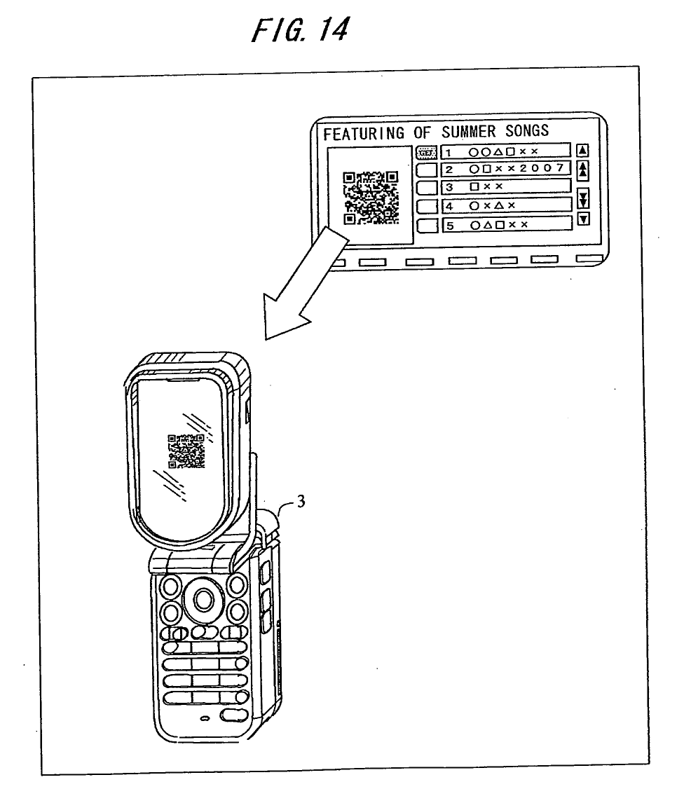

A code process and a release key transmitting process executed by the mobile terminal 3 will be described. FIG. 13 illustrates a flow of the code process and the release key transmitting process. In step S21, the QR code is acquired. To be specific, after the code generating process, the mobile terminal 3 reads the QR code, whereby the QR code is read into the mobile terminal 3. Herein, FIG. 14 illustrates a state in which the mobile terminal 3 reads the QR code. As illustrated in FIG. 14, a QR code reading application is started up, whereby the QR code is imaged and thus read. The title and the ID of the music content and the URL are thereby acquired. Upon completion of the acquisition of the QR code, the operation proceeds to step S22. Note that the character codes, when generated, as described above, can be read on the mobile terminal 3 by employing the wireless communication technology such as Bluetooth and FeliCa.

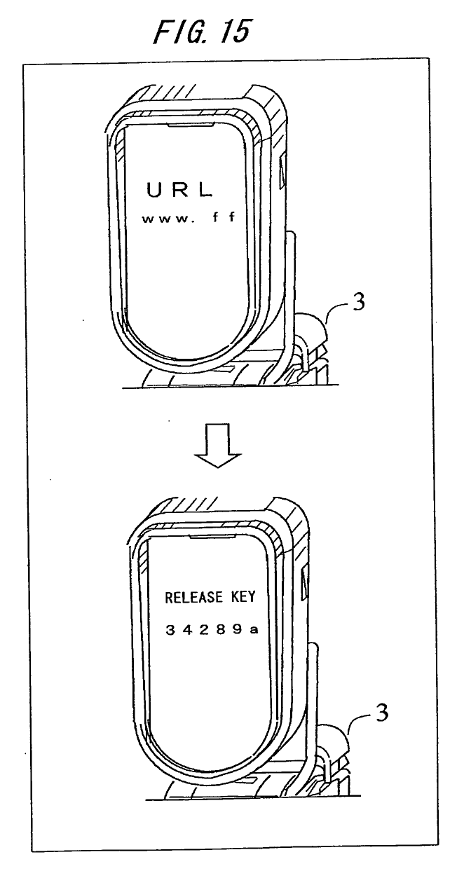

In step S22, the information needed for the purchase is inputted. Specifically. to begin with, an access to the URL contained in the QR code is started, then the Web page of the music content provider is displayed on the display unit 33 of the mobile terminal 3, and the user's identifying information necessary for the purchase is inputted via the operation unit 27 of the mobile terminal 3. When the user's identifying information necessary for the purchase is inputted, the content providing device 4 executes the accounting process and the release key issuing process. Herein, FIG. 15 illustrates a display status on the mobile terminal 3. As illustrated in FIG. 15, the URL is displayed in FIG. 15(a), and thereafter the release key is displayed as illustrated in FIG. 15(b). When the content providing device 4 issues the release key, the operation proceeds to step S23. Note that in-depth descriptions of the accounting process and the release key issuing process will be given later on.

In step S23, the code generating unit 33 acquires the release key, and the acquired release key is transferred to the navigation equipment 2 through the infrared-ray communications. The infrared-ray communications may be replaced with the wireless communication technology such as Bluetooth and FeliCa. It is to be noted that the navigation equipment 2 thereafter executes the decrypting process based on the acquired release key. Through the operation described above, the purchase of the music content is completed, it is feasible to execute the reproducing process of not only the catchy part but also all of the contents included in the music content information.

### (Accounting Process and Release Key Issuing Process)

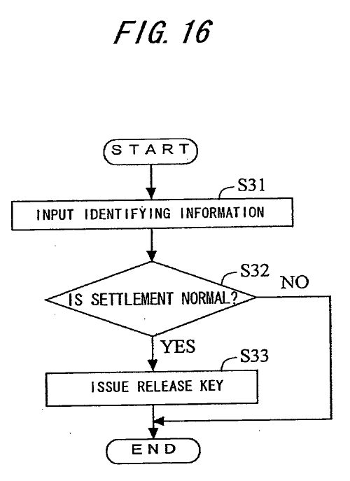

Next, the accounting process and the release key issuing process executed by the content providing device 4 will be described. FIG. 16 illustrates a flow of the accounting process and the release key issuing process. In step S31, the user's identifying information needed for the purchase is inputted via the Web page displayed on the mobile terminal 3. Subsequently in step S32, the accounting processing unit 47 determines whether settlement of account about the music content having the user's purchase request is normally done or not. If the settlement of account is normally executed, the operation proceeds to step S33. Whereas if the settlement of account is not normally executed. the accounting process and the release key issuing process are terminated.

In step S33, if the settlement of account is normally executed, the release key is issued. To be specific, the release key is issued when executing the encrypting process and is transmitted to the mobile terminal 3 when the settlement of account is normally executed.

### <Effects>

The content distribution system 100 according to the embodiment discussed above includes the transmitting device 1, whereby the various items of information can be transmitted. Further, it is feasible to charge the fee for purchasing the content and to acquire the release key by utilizing the mobile terminal 3, and hence, even when the navigation equipment 2 has no communication function, the content can be readily purchased. Moreover, the content distribution system 100 according to the embodiment can realize a series of processes such as distributing and purchasing the content by use of the existing infrastructures like the broadcasting waves and the network. Accordingly, it is possible to provide the system capable of easily distributing and purchasing the content with a small quantity of investment in equipment.

What is claimed is:

1. A data processing device comprising:
reproduction processing unit that reproduces a content distributed as carried on broadcasting waves;
display unit that displays an image making distinguishable the content that is in a reproducing process by said reproduction processing unit;
request accepting unit that accepts a purchase request for the content corresponding to the image displayed on said display unit; and
code generating unit that generates a predetermined code readable by a mobile terminal on the basis of unique identifying information contained in the content having the purchase request accepted by said request accepting unit.

2. A data processing device according to claim 1, wherein said code generating unit generates the predetermined code and gets the thus-generated predetermined code displayed in a way that replaces the image displayed on said display unit.

3. A data processing device according to claim 1, wherein the predetermined code is a QR code readable by a mobile terminal.

4. A data processing device according to claim 1, wherein the content is music content information on a piece of music.

5. A data processing method comprising:
a reproduction processing step of reproducing a content distributed as carried on broadcasting waves;
a displaying step of displaying an image making distinguishable the content that is in a reproducing process in said reproduction processing step;
a request accepting step of accepting a purchase request for the content corresponding to the image displayed in said displaying step; and
a code generating step of generating a predetermined code readable by a mobile terminal on the basis of unique identifying information contained in the content having the purchase request accepted in said request accepting step.

6. A data processing method according to claim 5, wherein said code generating step includes generating the predetermined code and getting the thus-generated predetermined code displayed in a way that replaces the image displayed in said displaying step.

7. A data processing method according to claim 5, wherein the predetermined code is a QR code readable by a mobile terminal.

8. A data processing method according to claim 5, wherein the content is music content information on a piece of music.
